(19) United States
(12) Patent Application Publication
(10) Pub. No.: US 2022/0385226 A1
(43) Pub. Date: Dec. 1, 2022

(54) CONTROL DEVICE FOR MOTOR GENERATOR

(71) Applicant: Mitsubishi Electric Corporation, Tokyo (JP)

(72) Inventor: Toshiyuki YOSHIZAWA, TOKYO (JP)

(73) Assignee: Mitsubishi Electric Corporation, Tokyo (JP)

(21) Appl. No.: 17/727,982

(22) Filed: Apr. 25, 2022

(30) Foreign Application Priority Data
Jun. 1, 2021 (JP) 2021-092288

(51) Int. Cl. H02P 29/68; H02P 9/02

(52) U.S. Cl. CPC H02P 29/68; H02P 9/02

(57) ABSTRACT

Provided is a control device for a motor generator, which enables suppression of a temperature rise of a motor generator. The control device includes a storage unit, a first acquisition unit, a second acquisition unit, and a control unit. The storage unit stores a plurality of control maps for controlling a motor generator. The first acquisition unit acquires first temperature information being information about a temperature of a power converter. The second acquisition unit acquires second temperature information being information about a temperature of a rotating electric machine. The control unit controls the power converter with reference to the plurality of control maps. Each of the control maps contains data including a field current command value. The control unit selects a control map to be referred to from the plurality of control maps based on the first temperature information and the second temperature information.

### BACKGROUND OF THE INVENTION

### 1. Field of the Invention

This disclosure relates to a control device for a motor generator.

### 2. Description of the Related Art

A related-art control device for a rotating electric machine for a vehicle operates in an inverter power generation mode or a normal power generation mode when the rotating electric machine functions as a power generator. Specifically, a power generation mode of the control device is switched between the inverter power generation mode and the normal power generation mode in accordance with a rotational speed of a rotor of the rotating electric machine.

The inverter power generation mode is selected when the rotational speed of the rotor is less than a threshold value. The normal power generation mode is selected when the rotational speed of the rotor is equal to or higher than the threshold value (see, for example, Japanese Patent Application Laid-open No. 2003-61399).

The above-mentioned related-art control device for a rotating electric machine for a vehicle is not configured to switch the power generation mode in consideration of a temperature of the rotating electric machine. Thus, when the rotating electric machine is being operated, there is a fear in that the temperature of the rotating electric machine may exceed an allowable temperature.

### SUMMARY OF THE INVENTION

This disclosure has been made to solve the problem described above, and has an object to provide a control device for a motor generator, which enables suppression of a temperature rise of the motor generator.

According to at least one embodiment of this disclosure, there is provided a control device for a motor generator, including: a storage unit configured to store a plurality of control maps for controlling a motor generator, the motor generator including a rotating electric machine and a power converter configured to supply a field current and an armature current to the rotating electric machine; a first acquisition unit configured to acquire first temperature information being information about a temperature of the power converter; a second acquisition unit configured to acquire second temperature information being information about a temperature of the rotating electric machine; and a control unit configured to control the power converter with reference to the plurality of control maps, wherein each of the control maps contains data including a field current command value being a command value relating to the field current, and wherein the control unit selects a control map to be referred to from the plurality of control maps based on the first temperature information and the second temperature information.

According to this disclosure, it is possible to suppress a temperature rise of the motor generator.

### BRIEF DESCRIPTION OF THE DRAWINGS

FIG. 1 is a configuration diagram for illustrating a main part of a vehicle including a motor generator according to a first embodiment.

FIG. 2 is a configuration diagram for illustrating a motor generator system of FIG. 1.

FIG. 3 is a circuit diagram for illustrating an armature power conversion unit of FIG. 2.

FIG. 4 is a table for showing a set of control maps used in an inverter power generation mode.

FIG. 5 is an explanatory graph for showing a method of limiting a field current or an armature current.

FIG. 6 is a table for showing a set of control maps used in an alternator power generation mode.

FIG. 7 is a flowchart for illustrating a power generation control command value determination routine executed by a control unit of FIG. 2.

FIG. 8 is a configuration diagram for illustrating a first example of a processing circuit for implementing each of functions of a control unit in a control device for a motor generator according to each of a first embodiment, a second embodiment, and a third embodiment.

FIG. 9 is a configuration diagram for illustrating a second example of the processing circuit for implementing each of the functions of the control unit in the control device for a motor generator according to each of the first embodiment, the second embodiment, and the third embodiment.

### DESCRIPTION OF THE EMBODIMENTS

Now, embodiments of this disclosure are described with reference to the drawings.

### First Embodiment

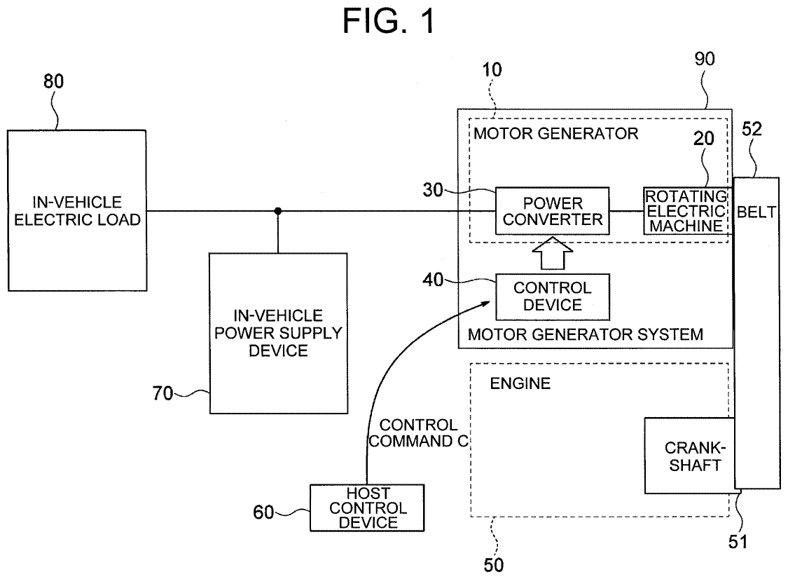

FIG. 1 is a configuration diagram for illustrating a main part of a vehicle including a motor generator according to a first embodiment. The vehicle includes a motor generator system 90, an engine 50, a host control device 60, an in-vehicle power supply device 70, and an in-vehicle electric load 80. The motor generator system 90 includes a motor generator 10 and a control device 40.

The motor generator 10 includes a rotating electric machine 20 and a power converter 30. The rotating electric machine 20 is electrically connected to the in-vehicle power supply device 70 and the in-vehicle electric load 80 through the power converter 30.

The control device 40 controls the power converter 30 based on a control command C from the host control device 60.

The engine 50 includes a crankshaft 51 and a belt 52. The crankshaft 51 is connected to a rotary shaft of the rotating electric machine 20 through the belt 52. Thus, a rotational torque of the engine 50 is transmitted to the rotating electric machine 20, and a rotational torque of the rotating electric machine 20 is transmitted to the engine 50.

For example, an engine control unit (ECU) is used as the host control device 60. The host control device 60 is configured to control the engine 50 and peripherals to be connected to the engine 50.

A chargeable secondary battery is used as the in-vehicle power supply device 70. The secondary battery is, for example, a lithium ion secondary battery, a nickel hydrogen storage battery, a nickel cadmium storage battery, or a lead storage battery. The in-vehicle electric load 80 is an electrical device such as an auxiliary machine or an air conditioner.

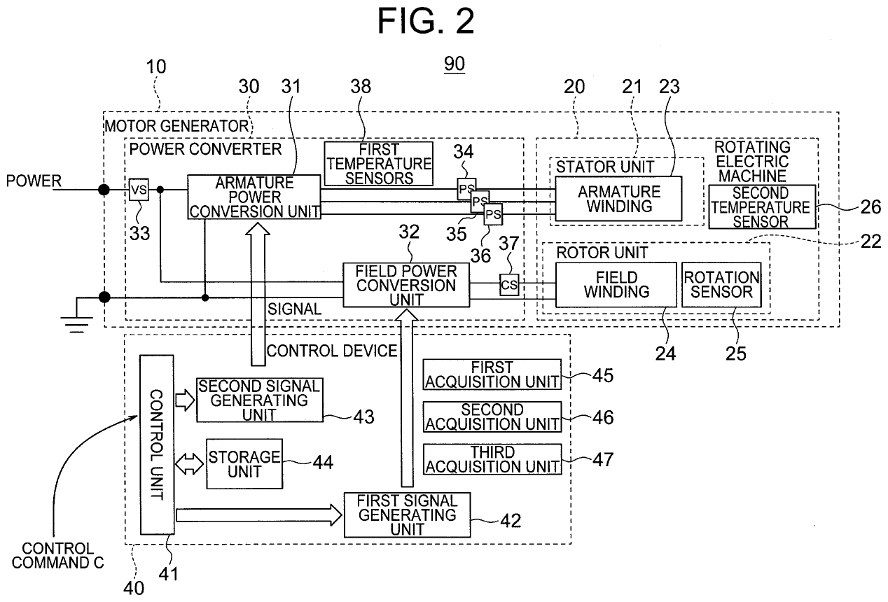

FIG. 2 is a configuration diagram for illustrating the motor generator system 90 of FIG. 1.

The rotating electric machine 20 includes a stator unit 21, a rotor unit 22, and a second temperature sensor 26. The stator unit 21 includes an armature winding 23 and a stator (not shown). The armature winding 23 includes, for example, a U-phase winding, a V-phase winding, and a W-phase winding, which are connected in a three-phase Y-connection. The U-phase winding, the V-phase winding, and the W-phase winding are wound around the stator.

The rotor unit 22 includes a field winding 24, a rotation sensor 25, and a rotor (not shown). The field winding is wound around the rotor. The rotation sensor 25 is configured to detect a rotational speed of the rotor. For example, a synchro resolver is used as the rotation sensor 25.

The second temperature sensor 26 is configured to detect a temperature of the rotating electric machine 20. For example, a thermistor is used as the second temperature sensor 26. The second temperature sensor 26 outputs information about the detected temperature of the rotating electric machine 20 to a control unit 41.

The power converter 30 includes an armature power conversion unit 31, a field power conversion unit 32, a terminal voltage sensor 33, a first armature current sensor 34, a second armature current sensor 35, a third armature current sensor 36, a field current sensor 37, and a plurality of first temperature sensors 38.

When the motor generator 10 functions as a motor, the armature power conversion unit 31 converts DC power into AC power as power supplied from the in-vehicle power supply device 70 to the armature winding 23. Further, when the motor generator 10 functions as a power generator, the armature power conversion unit 31 converts AC power generated in the armature winding 23 into DC power.

More specifically, the armature power conversion unit 31 includes six power conversion elements. The six power conversion elements of the armature power conversion unit 31 are turned ON and OFF based on an instruction from the control device 40 to thereby control an armature current being a current flowing through the armature winding 23. The six power conversion elements are metal-oxide-semiconductor field-effect transistors (MOSFETs).

The field power conversion unit 32 is configured to convert power output from the in-vehicle power supply device 70 into field power being power supplied to the field winding 24. The field power conversion unit 32 forms, for example, an H-bridge circuit, and includes power conversion elements. The power conversion elements of the field power conversion unit 32 are turned ON and OFF based on an instruction from the control device 40, to thereby control a field current being a current flowing through the field winding 24. A MOSFET is used as each of the field power conversion elements.

The terminal voltage sensor 33 is provided between the in-vehicle power supply device 70 and each of the armature power conversion unit 31 and the field power conversion unit 32. The terminal voltage sensor 33 is configured to detect a voltage across terminals of the motor generator 10. The terminal voltage sensor 33 outputs information about the detected terminal voltage to the control unit 41.

The first armature current sensor 34 is provided between the armature power conversion unit 31 and the U-phase winding. The first armature current sensor 34 is configured to detect a U-phase current Iu being a current flowing through the U-phase winding. The first armature current sensor 34 outputs information about the detected U-phase current Iu to the control unit 41.

The second armature current sensor 35 is provided between the armature power conversion unit 31 and the V-phase winding. The second armature current sensor 35 is configured to detect a V-phase current Iv being a current flowing through the V-phase winding. The second armature current sensor 35 outputs information about the detected V-phase current Iv to the control unit 41.

The third armature current sensor 36 is provided between the armature power conversion unit 31 and the W-phase winding. The third armature current sensor 36 is configured to detect a W-phase current Iw being a current flowing through the W-phase winding. The third armature current sensor 36 outputs information about the detected W-phase current Iw to the control unit 41.

The field current sensor 37 is provided between the field power conversion unit 32 and the field winding 24. The field current sensor 37 is configured to detect a field current If. The field current sensor 37 outputs information about the detected field current If to the control unit 41.

The first temperature sensors 38 are provided to the six power conversion elements of the armature power conversion unit 31 on a one-to-one basis. Each of the first temperature sensors 38 is configured to detect a temperature of a corresponding one of the power conversion elements. Each of the first temperature sensors 38 outputs information about the detected temperature of the corresponding one of the power conversion elements to the control unit 41.

The control device 40 includes the control unit 41, a first signal generating unit 42, a second signal generating unit 43, a storage unit 44, a first acquisition unit 45, a second acquisition unit 46, and a third acquisition unit 47.

The control unit 41 controls the power converter 30 with reference to a plurality of control maps. Each of the control maps contains data including a field current command value. The field current command value is a command value relating to the field current. The control command C from the host control device 60 is input to the control unit 41.

The control unit 41 controls the first signal generating unit 42 to generate a field current control signal being a signal for controlling the field current based on the control signal C. The control unit 41 controls the second signal generating unit 43 to generate an armature current control signal being a signal for controlling the armature current based on the control signal C.

The first signal generating unit 42 generates the field current control signal. The field current control signal is a signal for allowing the control unit 41 to control the field current through the field power conversion unit 32. The first signal generating unit 42 outputs the generated field current control signal to the field power conversion unit 32. More specifically, the field current control signal is a signal for performing ON/OFF control on the field power conversion elements in the field power conversion unit 32. The field power conversion elements adjust a conduction ratio of the field current by changing a duty ratio of the field current control signal.

The control unit 41 controls the first signal generating unit 42 to generate a signal for performing ON/OFF control on the field power conversion elements so that a deviation of a field current value detected by the field current sensor 37 from a target field current value becomes zero. In this manner, the control unit 41 performs feedback control on the field current.

The second signal generating unit 43 generates three armature current control signals. The three armature current control signals are signals for allowing the control unit 41 to control the armature current through the armature power conversion unit 31. The second signal generating unit 43 outputs the generated three armature current control signals to the armature power conversion unit 31. Specifically, the three armature current control signals are signals for allowing the U-phase current to flow through the U-phase winding, the V-phase current to flow through the V-phase winding, and the W-phase current to flow through the W-phase winding, respectively. In other words, the three armature current control signals are signals for performing ON/OFF control on the six power conversion elements of the armature power conversion unit 31.

The storage unit 44 stores the plurality of control maps. The plurality of control maps stored in the storage unit 44 are referred to by the control unit 41.

The first acquisition unit 45 acquires first temperature information from six first temperature sensors 38. The first temperature information is information about a temperature of the power converter 30. Specifically, the first acquisition unit 45 acquires temperature information about the six power conversion elements from the six first temperature sensors 38. The first acquisition unit 45 selects and uses, for example, the largest temperature from six acquired temperatures as a representative value of the temperatures of the power conversion elements.

The second acquisition unit 46 acquires second temperature information from the second temperature sensor 26. The second temperature information is information about a temperature of the rotating electric machine 20.

The third acquisition unit 47 acquires a rotational speed information of the rotor unit 22 from the rotation sensor 25.

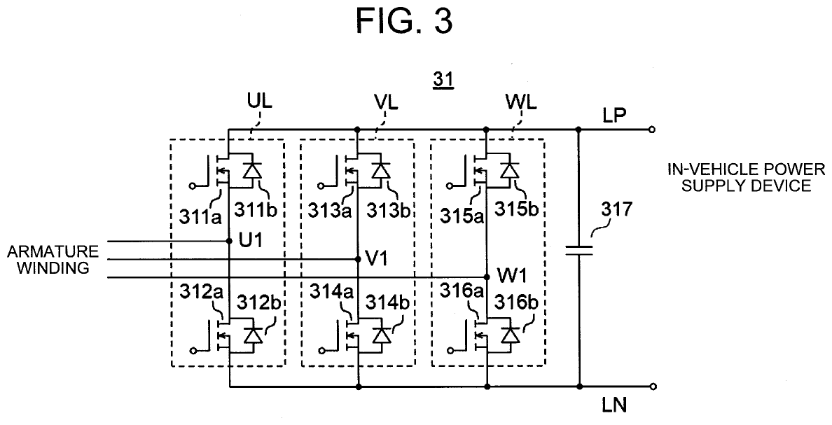

FIG. 3 is a circuit diagram for illustrating the armature power conversion unit 31 of FIG. 2. The armature power conversion unit 31 is a three-phase bridge circuit including a U-phase leg UL, a V-phase leg VL, and a W-phase leg WL.

The U-phase leg UL includes a U-phase upper arm and a U-phase lower arm. The U-phase upper arm includes a power conversion element 311a and a diode 311b, and the U-phase lower arm includes a power conversion element 312a and a diode 312b. The V-phase leg VL includes a V-phase upper arm and a V-phase lower arm. The V-phase upper arm includes a power conversion element 313a and a diode 313b, and the V-phase lower arm includes a power conversion element 314a and a diode 314b. The W-phase leg WL includes a W-phase upper arm and a W-phase lower arm. The W-phase upper arm includes a power conversion element 315a and a diode 315b, and the W-phase lower arm includes a power conversion element 316a and a diode 316b.

A connection point U1 between a pair of power conversion elements in the U-phase leg UL is connected to the U-phase winding through the first armature current sensor 34. A connection point V1 between a pair of power conversion elements in the V-phase leg VL is connected to the V-phase winding through the second armature current sensor 35. A connection point W1 between a pair of power conversion elements in the U-phase leg WL is connected to the W-phase winding through the third armature current sensor 36.

A smoothing capacitor 317 is connected between a positive-pole side wiring LP and a negative-pole side wiring LN to be located on a side closer to the in-vehicle power supply device 70. The smoothing capacitor 317 is configured to smooth a DC ripple component in the armature power conversion unit 31.

When receiving the control command C for a motor mode from the host control device 60, the control unit 41 can execute motor control. The motor control is control for allowing the motor generator 10 to operate as a motor through inverter control on the plurality of power conversion elements in the power converter 30.

The control unit 41 controls the power converter 30 based on the control command C for the motor mode. Through the control performed by the control unit 41, power from the in-vehicle power supply device 70 is supplied to the armature winding 23 and the field winding 24 to thereby cause the rotating electric machine 20 to generate torque.

The control unit 41 performs ON/OFF control on the power conversion elements connected to the respective phases of the armature power conversion unit 31 based on the armature current control signals generated by the second signal generating unit 43. In this manner, the armature winding 23 is energized with an armature current Ia. Specifically, the control unit 41 performs ON/OFF control on the power conversion elements based on pulse width modulation (PWM) signals generated by the second signal generating unit 43 to thereby energize the armature winding 23.

The control unit 41 performs feedback control on the armature current Ia based on the rotational speed detected by the rotation sensor 25, rotor magnetic-pole position information, a detection value given by the first armature current sensor 34, a detection value given by the second armature current sensor 35, and a detection value given by the third armature current sensor 36. In this manner, the control unit 41 adjusts the field current If and ON and OFF of the power conversion elements so that the torque generated by the rotating electric machine 20 becomes equal to a torque indicated by the control command C from the host control device 60.

When receiving the control command C for a power generation mode from the host control device 60, the control unit 41 can execute power generation control. The power generation control is control for allowing the motor generator 10 to operate as a power generator.

At the time of power generation control, the rotor unit 22 of the rotating electric machine 20 is rotated with motive power from the engine 50. In the power generation control, when the control unit 41 controls the field power conversion unit 32 to energize the field winding 24 with the field current If, a magnetic flux generated from the field winding 24 is interlinked with the armature winding 23. As a result, a voltage is induced in the armature winding 23.

The control unit 41 turns ON and OFF the plurality of power conversion elements 311a to 316a of the armature power conversion unit 31 in accordance with the induced voltage being the voltage induced in the armature winding 23. With this, the rotating electric machine 20, and the in-vehicle power supply device 70 and the in-vehicle electric load 80 are connected to each other, and the voltage is clipped. As a result, a current generated through the power generation flows. Thus, power is supplied to the in-vehicle power supply device 70 and the in-vehicle electric load 80.

When the induced voltage is higher than an output voltage from the in-vehicle power supply device 70, the control unit 41 can execute alternator power generation control for power generation performed in an alternator power generation mode. In the alternator power generation mode, synchronous power generation control or diode power generation control is executed.

In the synchronous power generation control, the control unit 41 turns ON and OFF the power conversion elements 311a to 316a of the armature power conversion unit 31 in accordance with a frequency that is synchronized with the rotational speed of the rotor to thereby energize the power conversion elements 311a to 316a. As a result, power is generated. In the diode power generation control, the diodes 311b to 316b connected in parallel to the power conversion elements 311a to 316a, respectively, that is, parasitic diodes are energized to thereby generate power.

Meanwhile, when the induced voltage is lower than the output voltage from the in-vehicle power supply device 70, the control unit 41 can execute inverter power generation control for power generation performed in the inverter power generation mode. In the inverter power generation control, the motor generator 10 is caused to generate power through inverter control performed on the plurality of power conversion elements 311a to 316a in the armature power conversion unit 31. In the inverter power generation control, the control unit 41 controls the armature power conversion unit 31 to boost the induced voltage. The induced voltage can be boosted by PWM operations of the power conversion elements 311a to 316a of the armature power conversion unit 31, which are caused through the second signal generation unit 43.

When the power conversion elements 311a to 316a of the armature power conversion unit 31 are turned ON and OFF at a high frequency of several kHz in the inverter power generation control, a switching loss in each of the power conversion elements 311a to 316a increases. Thus, power conversion efficiency at the time of inverter power generation control is lower than that at the time of alternator power generation control.

However, the rotating electric machine 20 may have a high temperature depending on a mounting position of the rotating electric machine 20 in the vehicle, a running state of the vehicle, and a self-heating state of the rotating electric machine 20. When the power converter 30 and the control device 40 are placed under a suitable temperature environment, it is preferred that the power generation mode be determined based on the temperature of the rotating electric machine 20 and the temperature of the power converter 30. The suitable temperature environment includes, for example, an environment in which an atmospheric temperature is relatively low and an environment in which relatively high cooling performance is achieved.

Further, also when the temperature of the rotating electric machine 20 is higher than the temperature of the power converter 30, it is preferred that the power generation mode be determined based on the temperature of the rotating electric machine 20 and the temperature of the power converter 30. Further, it is desired that the temperatures detected by the first temperature sensors 38 and the temperature detected by the second temperature sensor 26 do not exceed respective allowable temperatures.

Thus, the control device 40 for a motor generator according to the first embodiment performs the power generation control by selecting a control map to be referred to from a plurality of control maps prepared in advance based on the temperatures detected by the first temperature sensors 38 and the temperature detected by the second temperature sensor 26.

In particular, the inverter power generation control involves energization control performed on the field winding 24 and energization control performed on the armature winding 23.

In general, when the field current is constant, the induced voltage in the rotating electric machine 20 becomes higher as the rotational speed of the rotor unit 22 increases. Thus, the power generation mode is switched based on the rotational speed of the rotor. More specifically, when the rotational speed of the rotor is equal to or higher than a reference rotational speed, the alternator power generation mode is selected and the control unit 41 executes the alternator power generation control. When the rotational speed of the rotor is lower than the reference rotational speed, the inverter power generation mode is selected and the control unit 41 executes the inverter power generation control.

The control unit 41 is operable in at least two power generation modes, that is, the inverter power generation mode and the alternator power generation mode. The storage unit 44 stores sets of a plurality of control maps corresponding to the two power generation modes, that is, the inverter power generation mode and the alternator power generation mode, respectively.

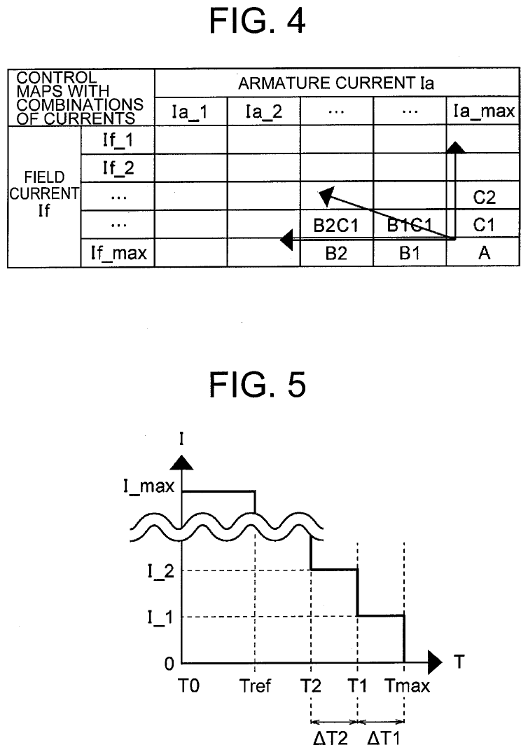

When the control unit 41 operates in the inverter power generation mode, the field current If and the armature current Ia are controlled. FIG. 4 is a table for showing a set of control maps used in the inverter power generation mode.

In the set of the control maps, “m” field currents from a field current If_1 to a maximum field current If_max are arranged in the stated order in a vertical direction, in which “m” is a natural number and the maximum field current If_max is an allowable maximum field current. A magnitude of the field current If_1 is 1/m of a magnitude of the maximum field current If_max. Specifically, the entire range of the field current If from the field current If_1 to the maximum field current If_max is divided by “m”.

In the set of the control maps, “n” armature currents from an armature current Ia_1 to a maximum armature current Ia_max are arranged in the stated order in a horizontal direction, in which “n” is a natural number and the maximum armature current Ia_max is an allowable maximum armature current. A magnitude of the armature current Ia_1 is 1/n of a magnitude of the maximum armature current Ia_max. Specifically, the entire range of the armature current Ia from the armature current Ia_1 to the maximum armature current Ia_max is divided by “n”.

The number of combinations of the field current If and the armature current Ia, which are obtained by the divisions described above, is m×n. In the first embodiment, the control maps are set for m×n combinations, respectively. Each of the control maps defines a relationship between a set of the control command C from the host control device 60, the rotational speed of the rotor unit 22, and the terminal voltage of the motor generator 10, and a set of a field current command value If*, a d-axis current command value Id*, and a q-axis current command value Iq*. The control command C from the host control device 60 is, for example, a torque command value.

For example, the field current command value If*, the d-axis current command value Id*, and the q-axis current command value Iq* in a control map stored in a cell “A” of FIG. 4 are set based on the maximum field current If_max and the maximum armature current Ia_max. Further, the field current command value If*, the d-axis current command value Id*, and the q-axis current command value Iq* in a control map stored in a cell “B1” of FIG. 4 are set based on the maximum field current If_max and a value of the armature current Ia, which is smaller than the maximum armature current Ia_max by (Ia_max/n).

Similarly, the field current command value If*, the d-axis current command value Id*, and the q-axis current command value Iq* in a control map stored in a cell “C1” of FIG. 4 are set based on a value of the field current If, which is smaller than the maximum field current If_max by (If_max/m) and the maximum armature current Ia_max. As described above, the value of the armature current Ia to be used for setting decreases leftward from the cell “A”. The value of the field current If to be used for setting decreases upward from the cell “A”.

Relationships expressed by the following three expressions are established among the armature current Ia, the d-axis current Id, and the q-axis current Iq. In the expressions, θ represents an angle formed between an α-axis and a d-axis of a coordinate system at rest. In the expressions, sqrt(Id²+Iq²) represents a square root of Id²+Iq², and sqrt(3) represents a square root of 3.

Ia=sqrt(Id²+Iq²)/sqrt(3)

Id=sqrt(3)×Ia×sin θ

Iq=sqrt(3)×Ia×cos θ

Assuming that generation of heat from the rotating electric machine 20 is due to a copper loss occurring in the armature winding 23, it is considered that the copper loss is determined by the field current If and the armature current Ia. Thus, when the temperature of the rotating electric machine 20 is high, the control unit 41 decreases at least any one of the value of the filed current If and the value of the armature current Ia in FIG. 4.

Meanwhile, a combination of the field current If, the d-axis current Id, and the q-axis current Iq, which is required to generate a request torque, is uniquely determined in a calculation for copper loss minimization control. Specifically, for example, in FIG. 4, when the field current If is changed from If_max to If_max-If_max/m located immediately above, the request torque cannot be obtained with the same value of the d-axis current Id and the same value of the q-axis current Iq. In this case, the d-axis current Id and the q-axis current Iq are required to be changed.

Thus, the control unit 41 reassigns the d-axis current Id and the q-axis current Iq within a range in which the armature current Ia is equal to or smaller than an allowable maximum value. Control maps obtained by calculations performed under conditions changed as described above are stored in cells “C1”, “B1C1”, “B2C1”, and so on.

For example, when the temperature of the rotating electric machine 20 exceeds a second reference temperature, the control unit 41 selects the control maps one after another in the vertical direction, for example, in the order of “A”, “C1”, “C2”, and so on. When the temperature of the power converter 30 exceeds a first reference temperature, the control unit 41 selects the control maps one after another in the horizontal direction, for example, in the order of “A”, “B1”, “B2”, and so on. When the temperature of the rotating electric machine 20 exceeds the second reference temperature and the temperature of the power converter 30 exceeds the first reference temperature, the control unit 41 selects the control maps one after another in a diagonally upward direction to the left, for example, in the order of “A”, “B1C1”, and so on.

Hysteresis is set in the selection control so as to prevent frequent occurrence of hunting in the field current If and the armature current Ia at the time of selection of a control map.

FIG. 5 is an explanatory graph for showing a method of limiting the field current If or the armature current Ia. In FIG. 5, a horizontal axis represents a temperature T, and a vertical axis represents a current I. The temperature T is the temperature of the rotating electric machine 20 or the temperature of the power converter 30. The current I is the field current If or the armature current Ia.

For example, when the current I is the field current If, and the temperature T is the temperature of the rotating electric machine 20 and is equal to a temperature T0, it is defined that the field winding can be energized with a current I_max as the field current If. When the temperature T exceeds a reference value Tref serving as the second reference temperature, the field current If starts being limited. For example, when the temperature T increases and reaches Tmax, the field current If is limited to 0. In other words, the operations of the rotating electric machine 20 and the power converter 30 are stopped. Specifically, the temperature Tmax is an operation stop temperature for the rotating electric machine 20 and the power converter 30.

Within the range of from the operation stop temperature Tmax to a temperature T1 that is lower than the operation stop temperature Tmax by ΔT1, the current value is limited to I_1. Within the range of from the temperature T1 to a temperature T2 that is lower than the temperature T1 by ΔT2, the current value is limited to I_2. In this manner, the current value is limited in a stepwise manner in the range of from the temperature T0 to the operation stop temperature Tmax.

The stepwise limitation is now defined for each of the field current If and the armature current Ia. For example, the field current If is gradually limited in “m” steps, and the armature current Ia is gradually limited in “n” steps. Combinations of the limitations on the currents correspond to the combinations of the plurality of control maps in FIG. 4.

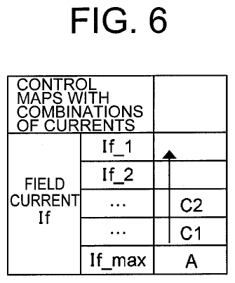

When the control unit 41 operates in the alternator power generation mode, only the field current If is controlled. FIG. 6 is a table for showing a set of control maps used in the alternator power generation mode. When the control unit 41 operates in the alternator power generation mode, the armature current Ia is not controlled. Thus, the set of the plurality of control maps corresponds to a set of field currents If_1 to If_max, which are obtained by dividing the entire range of the field current If by “m”, as shown in FIG. 6.

When the temperature of the rotating electric machine 20 is less than the second reference temperature, a control map stored in a cell “A” of the table of FIG. 6 is selected. Thus, in this case, a limit value of the field current If is If_max. When the temperature of the rotating electric machine 20 exceeds the second reference temperature, a control map stored in a cell “C1” of the table of FIG. 6 is selected.

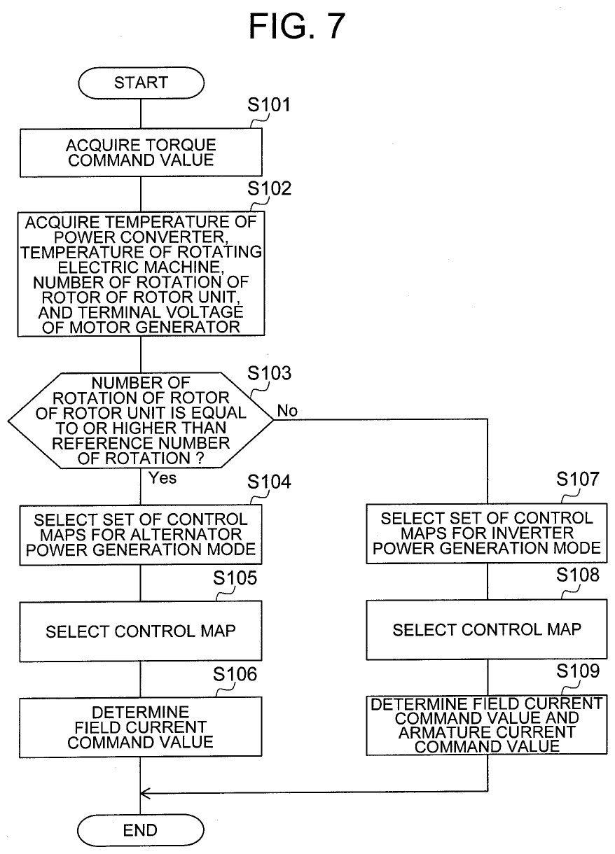

FIG. 7 is a flowchart for illustrating a power generation control command value determination routine executed by the control unit 41 of FIG. 2. The routine of FIG. 7 is to be executed, for example, each time the control command C from the host control device 60 is received.

After the routine of FIG. 7 is started, in Step S101, the control unit 41 acquires a torque command value from the host control device 60. Subsequently, in Step S102, the control unit 41 acquires the temperature of the power converter 30, the temperature of the rotating electric machine 20, the rotational speed of the rotor unit 22, and the terminal voltage of the motor generator 10.

Subsequently, in Step S103, the control unit 41 determines whether or not the rotational speed of the rotor unit 22 is equal to or higher than the reference rotational speed.

When the rotational speed of the rotor unit 22 is equal to or higher than the reference rotational speed, in Step S104, the control unit 41 selects the set of control maps for the alternator power generation mode.

Subsequently, in Step S105, the control unit 41 selects a control map based on the second temperature information. More specifically, the control unit 41 determines whether or not the temperature of the rotating electric machine 20 is equal to or higher than the second reference temperature.

When the temperature of the rotating electric machine 20 is equal to or higher than the second reference temperature, the control unit 41 selects a control map containing data including a maximum value of the field current command value, which is smaller than a maximum value of the field current command value in a currently selected control map.

For example, when the currently selected control map is a control map stored in a cell “C1” of FIG. 6, the control unit 41 selects a control map stored in a cell “C2” of FIG. 6. When the control is performed for the first time, the control unit 41 selects the control map stored in the cell “C1” of FIG. 6.

Meanwhile, when the temperature of the rotating electric machine 20 is lower than the second reference temperature, the control unit 41 selects a control map containing data including a maximum value of the field current command value, which is larger than the maximum value of the field current command value in the currently selected control map.

For example, when the currently selected control map is a control map stored in the cell “C1” of FIG. 6, the control unit 41 selects a control map stored in a cell “A” of FIG. 6. When the control is performed for the first time, the control unit 41 selects the control map stored in the cell “A” of FIG. 6.

Subsequently, in Step S106, the control unit 41 assigns the torque command value, the rotational speed of the rotor unit 22, and the terminal voltage of the motor generator 10 to the selected control map to thereby determine the field current command value. Then, this routine is terminated.

Further, when the rotational speed of the rotor unit 22 is equal to or lower than the reference rotational speed, in Step S107, the control unit 41 selects the set of control maps for the inverter power generation mode.

Subsequently, in Step S108, the control unit 41 selects a control map based on the first temperature information and the second temperature information.

For the selection of the control map, the following four specific cases are conceived.

(1) A case in which the temperature of the power converter 30 is equal to or higher than the first reference temperature and the temperature of the rotating electric machine 20 is equal to or higher than the second reference temperature.

(2) A case in which the temperature of the power converter 30 is equal to or higher than the first reference temperature and the temperature of the rotating electric machine 20 is lower than the second reference temperature.

(3) A case in which the temperature of the power converter is lower than the first reference temperature and the temperature of the rotating electric machine 20 is equal to or higher than the second reference temperature.

(4) A case in which the temperature of the power converter is lower than the first reference temperature and the temperature of the rotating electric machine 20 is lower than the second reference temperature.

(1) In the case in which the temperature of the power converter 30 is equal to or higher than the first reference temperature and the temperature of the rotating electric machine 20 is equal to or higher than the second reference temperature, the control unit 41 selects a control map on the upper left of the currently selected control map in FIG. 4.

For example, when the currently selected control map is a control map stored in the cell “A” of FIG. 4, the control unit 41 selects a control map stored in a cell “B1C1” of FIG. 4. When the control is performed for the first time, the control unit 41 selects the control map stored in the cell “B1C1” of FIG. 4.

(2) In the case in which the temperature of the power converter 30 is equal to or higher than the first reference temperature and the temperature of the rotating electric machine 20 is lower than the second reference temperature, the control unit 41 selects a control map on the left of the currently selected control map in FIG. 4.

For example, when the currently selected control map is a control map stored in the cell “A” of FIG. 4, the control unit 41 selects a control map stored in the cell “B1” of FIG. 4. When the control is performed for the first time, the control unit 41 selects the control map stored in the cell “B1” of FIG. 4.

(3) In the case in which the temperature of the power converter 30 is lower than the first reference temperature and the temperature of the rotating electric machine 20 is equal to or higher than the second reference temperature, the control unit 41 selects a control map above the currently selected control map in FIG. 4.

For example, when the currently selected control map is a control map stored in the cell “A” of FIG. 4, the control unit 41 selects a control map stored in the cell “C1” of FIG. 4. When the control is performed for the first time, the control unit 41 selects the control map stored in the cell “C1” of FIG. 4.

(4) In the case in which the temperature of the power converter 30 is lower than the first reference temperature and the temperature of the rotating electric machine 20 is lower than the second reference temperature, the control unit 41 selects a control map on the lower right of the currently selected control map in FIG. 4.

For example, when the currently selected control map is a control map stored in the cell “B1C1” of FIG. 4, the control unit 41 selects a control map stored in the cell “A” of FIG. 4. When the control is performed for the first time, the control unit 41 selects the control map stored in the cell “A” of FIG. 4. Further, when the field current If is If_max, the control unit 41 selects a control map on the right of the currently selected control map. When the armature current Ia is Ia_max, the control unit 41 selects a control map below the currently selected control map.

Subsequently, in Step S109, the control unit 41 assigns the torque command value, the rotational speed of the rotor unit 22, and the terminal voltage of the motor generator 10 to the selected control map to thereby determine the field current command value and the armature current command value. Then, this routine is terminated.

As described above, the control device 40 for a motor generator according to the first embodiment includes the storage unit 44, the first acquisition unit 45, the second acquisition unit 46, and the control unit 41. The storage unit 44 stores the plurality of control maps for controlling the motor generator 10. The motor generator 10 includes the rotating electric machine 20 and the power converter 30. The power converter 30 supplies the field current If and the armature current Ia to the rotating electric machine 20.

The first acquisition unit 45 acquires the first temperature information. The first temperature information is the information about the temperature of the power converter 30. The second acquisition unit 46 acquires the second temperature information. The second temperature information is the information about the temperature of the rotating electric machine 20. The control unit 41 controls the power converter 30 with reference to the plurality of control maps.

Each of the control maps contains the data including the field current command value. The field current command value is the command value relating to the field current If. The control unit 41 selects the control map to be referred to from the plurality of control maps based on the first temperature information and the second temperature information.

Thus, the control device 40 for a motor generator according to the first embodiment can control the motor generator 10 in a region in which the power generation control can be continued, by selecting a control map based on the temperature of the motor generator 10. Further, the motor generator 10 can be controlled in a region in which the motor control can be continued.

Thus, a temperature rise of the motor generator 10 can be suppressed. Further, the continued power generation control enables a reduction in load on the in-vehicle power supply device 70. As a result, degradation of the in-vehicle power supply device 70 can be suppressed.

Further, in the control device 40 for a motor generator according to the first embodiment, the plurality of control maps have different maximum values for the field current command value.

Thus, each time a different control map is selected, the maximum value of the field current command value changes. Hence, the temperature of the motor generator 10 can be more reliably changed by selecting a control map based on the temperature of the motor generator 10. Thus, a temperature rise of the motor generator 10 can be more reliably suppressed.

Further, when the temperature of the power converter 30 is higher than the first reference temperature, the control device 40 for a motor generator according to the first embodiment selects the control map containing the data including the maximum value of the field current command value, which is smaller than the maximum value of the field current command value in the currently selected control map, as the control map to be referred to. In this manner, a temperature rise of the motor generator 10 can be more reliably suppressed.

Further, when the temperature of the rotating electric machine 20 is higher than the second reference temperature, the control device 40 for a motor generator according to the first embodiment selects the control map containing the data including the maximum value of the field current command value, which is smaller than the maximum value of the field current command value in the currently selected control map, as the control map to be referred to. In this manner, a temperature rise of the motor generator 10 can be more reliably suppressed.

Further, in the control device 40 for a motor generator according to the first embodiment, the control unit 41 is capable of executing the inverter power generation control. The inverter power generation control is control for allowing the motor generator 10 to generate power through the inverter control on the plurality of power conversion elements 311a to 316a in the armature power conversion unit 31. The control map contains the data including the field current command value If* used in the inverter power generation control and the data including the armature current command value Ia* used in the inverter power generation control. The armature current command value Ia* is a command value relating to the armature current Ia.

Thus, at the time of the inverter power generation control, the field current command value If* and the armature current command value Ia* can be determined based on the control command with reference to the selected control map. Thus, the field current If and the armature current Ia are suitably controlled in accordance with the temperature of the motor generator 10. As a result, a temperature rise of the motor generator 10 can be more suitably suppressed.

Further, in the control device 40 for a motor generator according to the first embodiment, each of the control maps defines the relationship between the set of the torque command value for the rotating electric machine 20, the rotational speed of the rotor unit 22, and the terminal voltage of the motor generator 10, and the set of the armature current command value Ia* and the field current command value If*.

With the configuration described above, when the torque command value, the rotational speed of the rotor unit 22, and the terminal voltage of the motor generator 10 are assigned to the selected control map, the armature current command value Ia* and the field current command value If* are determined. Thus, the field current If and the armature current Ia are suitably controlled in accordance with the temperature of the motor generator 10. As a result, a temperature rise of the motor generator 10 can be more suitably suppressed.

Further, in the control device 40 for a motor generator according to the first embodiment, the second acquisition unit 46 acquires the information about the temperature of the field winding 24 of the rotating electric machine 20 as the second temperature information.

With the configuration described above, the current to energize the field winding 24 is controlled based on the temperature of the field winding 24. Thus, the alternator power generation control, the inverter power generation control, and the motor control can be performed with higher accuracy.

In the first embodiment, the temperature of the rotating electric machine 20 is detected by the thermistor. However, the temperature of the rotating electric machine 20 may be estimated in the following manner. For example, the temperature of the field winding 24 may be estimated by comparison between resistance values. Specifically, one of the resistance values is calculated based on a command current value for the field winding 24 and an application voltage value for energizing the field winding 24 with a current indicated by the command current value, and the other one of the resistance values is a resistance value at a normal temperature.

Further, as the amount of current flowing through the armature winding 23 increases, the temperature of the armature winding 23 rises. Further, as the amount of current flowing through the armature winding 23 increases, a larger amount of current flows through the power converter 30 to increase the temperatures of the power conversion elements 311a to 316a of the armature power conversion unit 31. Specifically, a change in temperature of the armature winding 23 and a change in temperature of the power converter 30 have similar tendencies. Thus, the temperature of the armature winding 23 may be estimated from the temperatures of the power conversion elements of the armature power conversion unit 31, that is, the temperatures detected by the first temperature sensors 38.

Further, in the first embodiment, MOSFETs are used as the field power conversion elements of the field power conversion unit 32 and the power conversion elements of the armature power conversion unit 31. However, other power conversion elements, for example, insulated gate bipolar transistors (IGBTs) may be used in place of the MOSFETs.

Further, switching to the alternator power generation mode or the inverter power generation mode is performed based on the rotational speed of the rotor. Instead, the switching may be performed based on a magnitude relationship between the induced voltage in the rotating electric machine 20 and the output voltage from the in-vehicle power supply device 70.

### Second Embodiment

Next, a control device for a motor generator according to a second embodiment is described. The control device for a motor generator according to the second embodiment includes a storage unit 44 configured to store a plurality of control maps used in a motor mode in addition to a plurality of control maps used in two power generation modes, specifically, the inverter power generation mode and the alternator power generation mode.

The control device for a motor generator according to the second embodiment is different from the control device for a motor generator according to the first embodiment only in that the control device according to the second embodiment controls a motor generator 10 with reference to the plurality of control maps used in the motor mode when the motor generator 10 operates in the motor mode.

Other configurations of the control device for a motor generator according to the second embodiment are the same as those of the control device according to the first embodiment.

When operating in the motor mode, the motor generator 10 is controlled by pulse width modulation (PWM) over an entire rotational speed range of a rotating electric machine 20. Thus, when the motor generator 10 operates in the motor mode, the field current If and the armature current Ia are required to be controlled. Thus, as in the case of the operation in the inverter power generation mode, a control device 40 according to the second embodiment controls the motor generator 10 by selecting a control map based on a temperature of the rotating electric machine 20 and a temperature of a power converter 30.

As described above, the control unit 41 of the control device 40 for the motor generator 10 according to the second embodiment can execute motor control. The motor control is control for allowing the motor generator 10 to operate as a motor through inverter control on a plurality of power conversion elements 311a to 316a in an armature power conversion unit 31. Each control map contains data including a field current command value and data including an armature current command value used in the motor control.

With the configuration described above, also when the motor generator 10 is used as a motor, a temperature rise of the motor generator 10 can be suppressed.

### Third Embodiment

Next, a motor generator system 90 according to a third embodiment is described. The motor generator system 90 according to the third embodiment is different from the motor generator systems described in the first and second embodiments only in that each of a power converter 30 and a control device 40 has a liquid cooling structure.

Other configurations of the motor generator system 90 according to the third embodiment are the same as those of the motor generator system 90 described in the first embodiment.

As described above, the motor generator system 90 according to the third embodiment includes a motor generator 10 and the control device 40. Each of the power converter 30 and the control device 40 has a liquid cooling structure.

The liquid cooling structures improve cooling performance of the power converter 30 and the control device 40. Thus, a temperature rise of the power converter 30 and a temperature rise of the control device 40 are suppressed, and hence power generation control on the motor generator 10 and motor control on the motor generator 10 can easily be continued.

A rotor unit 22 of a rotating electric machine 20 is provided inside a stator unit 21. Thus, heat easily builds up in the rotor unit 22. Thus, even when the power converter 30 and the control device 40 are liquid-cooled, it is preferred that a control map for the field current If and the armature current Ia or a control map for the field current If be selected based on the temperature of the rotating electric machine 20.

Further, the motor generators 10 according to the first to third embodiments have the same effects regardless of whether the rotating electric machine 20 and the power converter 30 are integrated with each other or provided separately.

Further, the armature winding is a three-phase winding in the first to third embodiments. However, the number of phases is not limited to three. For example, the armature winding may be a multiphase winding or a multiphase and multigroup winding.

Still further, the field winding 24 is rotated together with the rotor in the rotor unit 22 described in the first to third embodiments. However, rotor unit 22 may be divided into a field winding portion and a magnetic pole portion. In this case, the field winding portion is not rotated together with the rotor, and the magnetic pole portion is rotated together with the rotor. This configuration enables easy detection of a temperature of the field winding portion with use of a temperature sensor. Thus, the motor generator can be controlled with higher accuracy.

Still further, in the first to third embodiments, the control device 40 is mounted separately from the ECU of the vehicle, which serves as the host control device. However, the control device 40 may be built in the ECU.

Still further, the control device 40 may be mounted not only in a vehicle but also in, for example, a train, a ship, or an industrial machine.

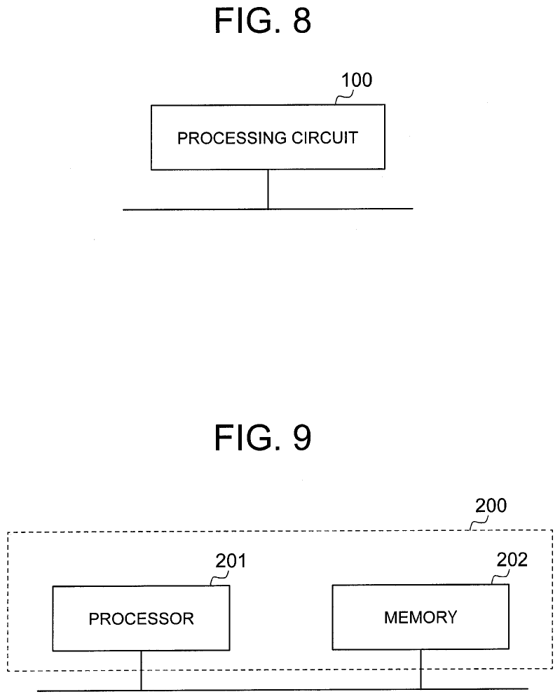

Still further, the functions of the control devices for a motor generator according to the first to third embodiments are implemented by a processing circuit. FIG. 8 is a configuration diagram for illustrating a first example of the processing circuit for implementing each of the functions of the control devices 40 for a motor generator according to the first to third embodiments. A processing circuit 100 of the first example is dedicated hardware.

Further, the processing circuit 100 corresponds to, for example, a single circuit, a complex circuit, a programmed processor, a processor for a parallel program, an application specific integrated circuit (ASIC), a field programmable gate array (FPGA), or a combination thereof.

Further, FIG. 9 is a configuration diagram for illustrating a second example of the processing circuit for implementing each of the functions of the control devices 40 for a motor generator according to the first to third embodiments. A processing circuit 200 of the second example includes a processor 201 and a memory 202.

In the processing circuit 200, the functions of the control device 40 for a motor generator are implemented by software, firmware, or a combination of software and firmware. The software and the firmware are described as programs to be stored in the memory 202. The processor 201 is configured to read out and execute the programs stored in the memory 202, to thereby implement the respective functions.

The programs stored in the memory 202 can also be regarded as programs for causing a computer to execute the procedure or method of each of the above-mentioned units. In this case, the memory 202 corresponds to, for example, a nonvolatile or volatile semiconductor memory, such as a random access memory (RAM), a read only memory (ROM), a flash memory, an erasable programmable read only memory (EPROM), or an electronically erasable and programmable read only memory (EEPROM). Further, a magnetic disk, a flexible disk, an optical disc, a compact disc, a mini disc, or a DVD may also correspond to the memory 202.

The function of each control device 40 for a motor generator described above may be implemented partially by dedicated hardware, and partially by software or firmware.

In this way, the processing circuit can implement the function of each of the above-mentioned control device 40 for a motor generator by hardware, software, firmware, or a combination thereof.

What is claimed is:

1. A control device for a motor generator, comprising:
a storage circuitry to store a plurality of control maps for controlling a motor generator, the motor generator including a rotating electric machine and a power converter configured to supply a field current and an armature current to the rotating electric machine;
a first acquisition circuitry to acquire first temperature information being information about a temperature of the power converter;
a second acquisition circuitry to acquire second temperature information being information about a temperature of the rotating electric machine; and
a controller to control the power converter with reference to the plurality of control maps,
wherein each of the control maps is configured to contain data including a field current command value being a command value relating to the field current, and
wherein the controller is configured to select a control map to be referred to from the plurality of control maps based on the first temperature information and the second temperature information.

2. The control device for a motor generator according to claim 1, wherein the plurality of control maps are configured to contain different maximum values for the field current command value, respectively.

3. The control device for a motor generator according to claim 2, wherein, when a temperature of the power converter is higher than a first reference temperature, the controller is configured to select a control map containing data including a maximum value of the field current command value, the maximum value being smaller than a maximum value of the field current command value in a currently selected control map, as the control map to be referred to.

4. The control device for a motor generator according to claim 2, wherein, when a temperature of the rotating electric machine is higher than a second reference temperature, the controller is configured to select a control map containing data including a maximum value of the field current command value, the maximum value being smaller than a maximum value of the field current command value in a currently selected control map, as the control map to be referred to.

5. The control device for a motor generator according to claim 1,
wherein the controller is capable of executing inverter power generation control,
wherein the inverter power generation control is control for allowing the motor generator to generate power through inverter control on a plurality of power conversion elements of the power converter, and
wherein each of the control maps is configured to contain data including the field current command value used in the inverter power generation control and data including an armature current command value that is a command value relating to the armature current, and is used in the inverter power generation control.

6. The control device for a motor generator according to claims 1,
wherein the controller is capable of executing motor control,
wherein the motor control is control for allowing the motor generator to operate as a motor through inverter control on a plurality of power conversion elements of the power converter, and
wherein each of the control maps is configured to contain data including the field current command value used in the motor control and data including an armature current command value that is a command value relating to the armature current, and is used in the motor control.

7. The control device for a motor generator according to claim 5, wherein each of the control maps is configured to define a relationship between a set of a torque command value for the rotating electric machine, the rotational speed of a rotor of a rotor unit of the rotating electric machine, and a terminal voltage of the motor generator, and a set of the armature current command value and the field current command value.

8. The control device for a motor generator according to claim 6, wherein each of the control maps is configured to define a relationship between a set of a torque command value for the rotating electric machine, the rotational speed of a rotor of a rotor unit of the rotating electric machine, and a terminal voltage of the motor generator, and a set of the armature current command value and the field current command value.

9. The control device for a motor generator according to claim 1, wherein the second acquisition circuitry is configured to acquire information about a temperature of a field winding of the rotating electric machine as the second temperature information.
